(19) United States
(12) Patent Application Publication
(10) Pub. No.: US 2008/0250066 A1
(43) Pub. Date: Oct. 9, 2008

(54) APPARATUS AND METHOD FOR ADDING CONTACT INFORMATION INTO A CONTACT LIST

(75) Inventors: Simon D. Ekstrand, Eslov (SE); Oscar Heed, Malmo (SE); Anette C. Sandegard, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/696,881

(22) Filed: Apr. 5, 2007

(51) Int. Cl. G06F 7/00

(52) U.S. Cl. 707/104.1; 707/E17.005

(57) ABSTRACT

A portable electronic device includes call circuitry operative to establish a call with another contact over a communication network, a contact list stored in memory of the electronic device, said contact list including contact information; and logic circuitry operative to capture at least a portion of new contact information during a call with the contact, wherein the new contact information can be obtained via the communication network. The logic circuit automatically enters the new contact information into the contact list during or after the call.

### TECHNICAL FIELD OF THE INVENTION

The present invention relates generally to electronic devices, such as electronic devices for engaging in voice communications. More particularly, the invention relates to a device and method for adding and using contact information of a contact list in electronic devices.

### DESCRIPTION OF THE RELATED ART

Mobile and/or wireless items of electronic devices are becoming increasingly popular. For example, mobile telephones are now in wide-spread use. In addition, the features associated with certain types of electronic devices have become increasingly diverse. To name a few examples, many electronic devices include cameras, text messaging capability, Internet browsing functionality, electronic mail capability, video playback capability, audio playback capability, image display capability, navigation capability, and hands-free headset interfaces.

Conventional mobile telephones often include a contact list for storing contact information, such as phone numbers, email addresses, pictures, etc. of individuals known by a user of the mobile telephone. This information can be used for both incoming and outgoing calls. For example, as a call is received on the mobile telephone, an image and/or name can be displayed on a screen of the mobile telephone, and custom ring tones may be played to facilitate identification of the incoming call. For outgoing calls, a particular individual's contact information can be quickly retrieved and then used to place a call to that individual. In this context, the contact information is used as a personal phone book, containing phone numbers (or email addresses, etc.) of individuals that may be contacted by the user of the mobile telephone.

A drawback to conventional contact lists in conventional electronic devices is that it can be cumbersome to collect and enter the contact information. For example, to enter an image of an individual into the electronic device's contact list, the user first must transfer the image data to the electronic device. This typically is accomplished by using a camera function of the electronic device to snap a picture of the individual. As will be appreciated, this requires that the individual be in the immediate vicinity of the electronic device, which typically is not the case. Alternatively, the image data may be transferred from some other device (e.g., a personal computer or the like). If the image data is wirelessly transferred, then, prior to the transfer, the two devices need to be paired so as to establish a communication link between the devices. Once the link is established, the image data then can be transferred to the electronic device. Another way in which the image data may be transferred to the electronic device is via a portable memory device, such as a memory card or the like. Using a memory card, however, requires that the user manually perform a number of steps. These can include, for example, copying the image data from the source device to the memory card, removing the memory card from the source device and inserting it into the destination device (i.e., the electronic device), and then copying the image data from the memory card onto the electronic device.

Once the image data has been transferred onto the electronic device, additional steps are needed to associate the data with a particular contact in the contact list. First, the contact list must be opened and, if an entry already exists for the individual, the entry must be edited so as to include the new data. If the entry does not exist, then the entry must be created, which can include entering a name of the individual, the various contact data (e.g., phone number, email address, etc.) and the image data associated with that particular contact.

### SUMMARY

As is evident, the simple task of including contact information, such as image data, to an electronic device's contact list can be a tedious task. Moreover, conventional electronic devices can accept only a single image file for each entry in the contact list, which limits the personal creativity that may be implemented in creating the contact information.

The present invention provides a method and apparatus for easily and efficiently adding contact information, such as media content, to a contact list of an electronic device. The contact information can include, for example, image data such as photographs, movie data and/or audio data (including voice data). Contact information can be automatically added during communication with another individual. For example, during a video call, an image and/or movie clip may be captured by instructing the electronic device to capture the images displayed on its screen. The capture request may be initiated via a function key or the like (e.g., pressing a pre-programmed key on the electronic device, pressing a dedicated camera button on the electronic device, etc.). For example, to select between an image, movie (video and audio), or audio file, separate function keys may be defined for each type of contact information, such that activation of the particular function key will implement the corresponding request (e.g., snap a picture, record a movie clip, record an audio clip, etc.).

Once the contact information has been captured, it can be automatically entered into the contact list. For example, the electronic device may know the current connection identifier (e.g., the phone number, VoIP IP address, etc.) of the party on the other end of the communication. Using the identifier, the electronic device can automatically access the contact list, search for the identifier in the contact list, and edit the contact list so as to include the new contact information. The contact information then may be displayed on the electronic device and/or audio may be played via the electronic device's speakers as a call from a corresponding individual is incoming or outgoing. If the identifier is not in the contact list, an entry may be automatically created in the contact list.

Additionally, multiple contact information (e.g., multiple images, video clips and/or audio clips) may be stored for a particular contact in the contact list. Metadata or tags then may be associated with respective contact information so as to provide a unique experience to the user. For example, four different images of an individual may be stored in the electronic device, wherein each image is from a different time of year (e.g., spring, summer, winter and fall). The seasonal periods associated with each image may be stored with the image data as metadata. Then, as the seasons change, the image presented on the electronic device's display also may change so as to correspond with the season. Other examples include presenting the stored contact information based on the time of day (e.g., morning, afternoon, night, etc.), holiday seasons (e.g., Christmas, Thanksgiving, etc.), and personal days (e.g., birthdays, anniversaries, etc.). Alternatively, all of the contact information (or a portion thereof) associated with a particular individual in the contact list may be displayed in a slide show format (e.g., each image is displayed for a predetermined amount of time, and then another image is displayed for a predetermined amount of time, etc.) as the call is initiated on the electronic device and/or incoming to the electronic device, as well as during the entire call. The contact information also may be shared between the two calling parties.

According to one aspect of the invention, a portable electronic device includes call circuitry operative to establish a call over a communication network; a contact list stored in memory of the electronic device, said contact list configured to store contact information for a plurality of contacts; and logic circuitry operative to capture at least a portion of new contact information during a call with a contact of the plurality of contacts, said new contact information obtained via the communication network, and to automatically enter the new contact information into the contact list during or after the call.

According to one aspect of the invention, the logic circuitry that automatically enters the new contact information includes logic circuitry operative to associate the new contact information with an identifier of the contact.

According to one aspect of the invention, the logic circuitry that associates the new contact information with the identifier includes logic circuitry operative to capture at least one of a name or number of the contact.

According to one aspect of the invention, the logic circuitry that associates the new contact information with the identifier includes logic circuitry operative to implement image recognition to match a new image with an existing image in the contact list, and to associate the new image with an identifier associated with the existing image.

According to one aspect of the invention, the logic circuit is further operative to capture at least one image of the contact, at least one video of the contact, or at least one audio clip of the contact.

According to one aspect of the invention, the at least one image is captured in response to a key actuation on the electronic device, said key corresponding to a capture command.

According to one aspect of the invention, the logic circuit is further operative to capture a plurality of images or a plurality of videos for a particular contact.

According to one aspect of the invention, the logic circuit is further operative to capture the contact information prior to answering the call.

According to one aspect of the invention, the logic circuit is further operative to store at least one tag with the contact information, said at least one tag corresponding to at least one of chronological data or geographical data associated with the contact.

According to one aspect of the invention, the logic circuit is further operative to use the contact information corresponding to a particular contact as an alert upon receiving a call from the particular contact.

According to one aspect of the invention, the logic circuit is further operative to use the at least one tag to determine which portion of the contact information to display on a display device of the electronic device or play through an audio output device of the electronic device.

According to one aspect of the invention, chronological data includes a time, a month, a date, or a season, and wherein geographical data includes a location of the contact.

According to one aspect of the invention, a method of using contact information in a contact list of a portable electronic device, wherein said portable electronic device includes call circuitry operative to establish a call over a communication network, includes: capturing at least a portion of new contact information during a call, said new contact information obtained via the communication network and corresponding to a contact; and automatically entering the new contact information into the contact list during or after the call.

According to one aspect of the invention, automatically entering the new contact information includes associating the new contact information with an identifier of the contact.

According to one aspect of the invention, associating the new contact information with the identifier includes implementing image recognition to match a new image with an existing image in the contact list, and associating the new image with an identifier associated with the existing image.

According to one aspect of the invention, capturing at least a portion of the contact information during the call includes capturing at least one image of the contact, at least one video of the contact, or at least one audio clip of the contact.

According to one aspect of the invention, capturing at least a portion of the contact information includes capturing at least one of a name, number, or IP address of the contact.

According to one aspect of the invention, capturing is initiated by actuating a key on the electronic device, said key corresponding to a capture command.

According to one aspect of the invention, capturing at least a portion of the contact information during the call includes capturing the contact information prior to answering the call.

According to one aspect of the invention, capturing at least one image or at least one video includes capturing a plurality of images or a plurality of videos of a particular contact.

According to one aspect of the invention, automatically entering the new contact information into the contact list includes storing at least one tag with the contact information, said at least one tag corresponding to at least one of chronological data or geographical data associated with the contact.

According to one aspect of the invention, the method further includes using the contact information corresponding to a particular contact as an alert upon receiving a call from the particular contact.

According to one aspect of the invention, using the contact information includes using the at least one tag to determine which portion of the contact information to use.

According to one aspect of the invention, using the contact information includes at least one of displaying the contact information on a display device of the electronic device or playing the contact information through an audio output device of the electronic device.

According to one aspect of the invention, chronological data includes a time, a month, a date, or a season, and wherein geographical data includes a location of the contact.

According to one aspect of the invention, a computer program embodied on a computer readable medium for using contact information in a contact list of a portable electronic device, wherein said portable electronic device includes call circuitry operative to establish a call with another contact over a communication network, includes: code that captures at least a portion of new contact information during a call with the contact, said new contact information obtained via the communication network and corresponding to a contact; and code that automatically enters the new contact information into the contact list during or after the call.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic view of a mobile telephone as an exemplary electronic device in accordance with an embodiment of the present invention.

FIG. 2 is a schematic block diagram of the relevant portions of the mobile telephone of FIG. 1 in accordance with an embodiment of the present invention.

FIG. 3 is a schematic diagram of a communications system in which the mobile telephone of FIG. 1 may operate.

FIG. 4A is an exemplary contact list that may be used in the mobile telephone of FIG. 1.

FIG. 4B is an exemplary entry in the contact list of FIG. 4A.

FIG. 5 is an exemplary entry in a contact list in accordance with the present invention.

FIG. 6 is a flow chart of an exemplary contact list manager function in accordance with the present invention.

FIG. 7 is a flow chart of an exemplary use of contact list information in accordance with the present invention.

FIG. 8 is a block diagram of an exemplary menu flow for entering characteristic information that will be associated with the contact information in accordance with the invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smart phones, portable communication apparatus or the like.

As used herein, the term “contact” refers to another person or party, such as, for example, a party to a telephone call, video call, or the like. The term “contact information” includes, but is not limited to, the contact's name, phone number, IP address, image of the contact, audio clip of the contact, and/or video clip of the contact. Further, there may be multiple entries for certain types of contact information (e.g., multiple images, audio clips, video clips).

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a portable gaming device, or the like.

Referring initially to FIGS. I and 2, an electronic device 10 is shown. The electronic device 10 includes a contact list manager function 12 that is configured to automatically add and display contact information of a contact list stored in the electronic device 10. More specifically, the contact list manager function 12 facilitates the capture of new contact information, such as audio and video media content, and the association of the newly captured media content with corresponding entries in the contact list. Additional details and operation of the contact list manager function 12 will be described in greater detail below. The contact list manager function 12 may be embodied as executable code that is resident in and executed by the electronic device 10. In one embodiment, the contact list manager function 12 may be a program stored on a computer or machine readable medium. The contact list manager function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

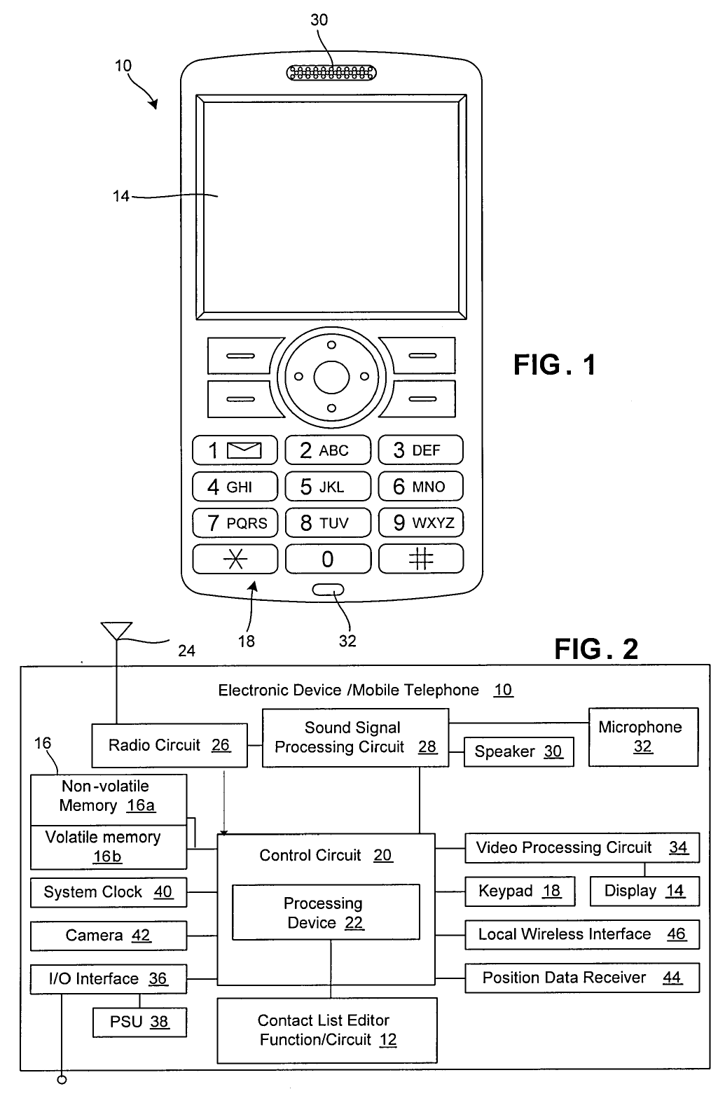

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth. FIG. 2 represents a functional block diagram of the mobile telephone 10. For the sake of brevity, generally conventional features of the mobile telephone 10 will not be described in great detail herein.

The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10.

The memory 16 may include a read only memory area that is implemented using nonvolatile memory 16a, and a random access or system memory area that is implemented using volatile memory 16b. As will be appreciated, nonvolatile memory tends not to lose data storage capability upon loss of power and is typically used to store data, application code, files and so forth. The nonvolatile memory 16a may be implemented with a flash memory, for example. The flash memory may have a NAND architecture, but other flash memory architectures, such as a NOR architecture, may be used. As will be appreciated, volatile memory tends to lose data storage capability upon loss of power and is typically used to store data for access by the processing device 22 during the execution of logical routines. The volatile memory 16b may be a random access memory (RAM). The RAM may be a synchronous dynamic random access memory (SDRAM), for example, but other RAM architectures that utilize memory blocks may be used. Data may be exchanged between the nonvolatile memory 16a and the volatile memory 16b as is conventional. The nonvolatile memory 16a and the volatile memory 16b may be sized as is appropriate for the mobile telephone 10 or other electronic device in which the memory 16 is used.

In addition, the processing device 22 may execute code that implements the contact list manager function 12. It will be apparent to a person having ordinary skill in the art of computer programming, and specifically in application programming for mobile telephones or other electronic devices, how to program a mobile telephone 10 to operate and carry out logical functions associated with the contact list manager function 12. Accordingly, details as to specific programming code have been left out for the sake of brevity. Also, while the contact list manager function 12 is executed by the processing device 22 in accordance with a preferred embodiment of the invention, such functionality could also be carried out via dedicated hardware, firmware, software, or combinations thereof, without departing from the scope of the invention. Any of these implementations may be referred to as a contact list manager circuit or simply a logic circuit.

Continuing to refer to FIGS. I and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

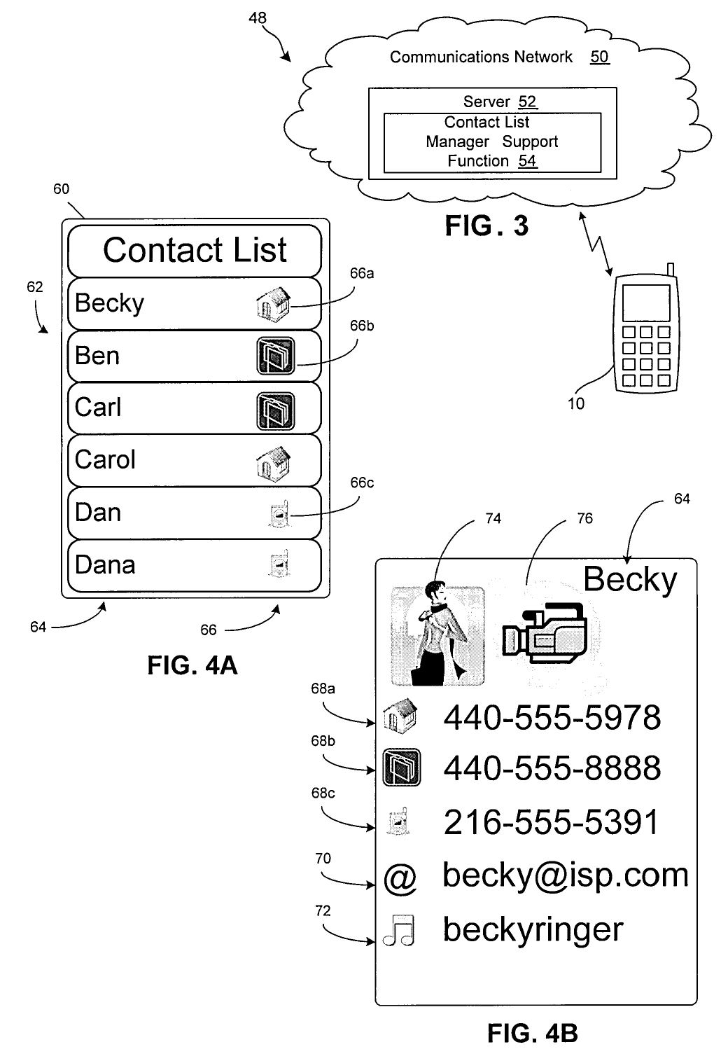

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software. In one embodiment, the server 52 may be configured to store and execute a contact list manager support function 54 that interacts with the contact list manager function 12 of the mobile telephone 10. Details of the contact list manager support function 54 will be described below in greater detail. In one embodiment, the contact list manager support function 54 may be a program stored on a computer or machine readable medium. The contact list manager support function 54 may be a stand-alone software application or may form a part of a software application that carries out additional tasks related to the functions of the server 54. In one embodiment, the functions of the contact list manager support function 54 may be distributed among multiple servers, including one or more servers located outside the domain of the communications network 50.

Referring now to FIG. 4A, an exemplary contact list 60 that may be used in the mobile telephone 10 is shown. The contact list 60 includes a plurality of entries 62, wherein each entry includes a unique identifier 64 (e.g., a name, number, IP address, etc.). Each entry also may include a graphical object or symbol 66 indicative of a first or primary contact number for each entry. For example, the “Becky” entry includes a symbol of a house 66a, which signifies the primary contact is a home number, while the “Ben” entry includes a symbol of a briefcase 66b, which signifies the primary contact is a work number. The “Dan” entry includes a symbol of a mobile phone 66c, which signifies that the primary contact is a mobile telephone number. Although not shown, there may be additional entries in the contact list 60 that may be viewed by scrolling up or down the contact list 60.

As is conventional, an entry 62 in the contact list 60 may be selected by using navigation keys of the mobile telephone 10 (e.g., up/down arrow keys or the like). A selected entry may be indicated, for example, by shading or changing the color of the entry 62. Alternatively, a search may be performed by entering the first few characters of the entry. For example, pressing the “5” key (JKL) one time will cause the contact list to jump to the first entry that begins with a “J”. When an entry is found, further detail may be obtained by selecting the entry (e.g., via a select key or the like), which may present a detailed view of the entry as shown in FIG. 4B.

FIG. 4B is a detailed view of an exemplary entry 62 of the contact list 60. The detailed view includes the identifier 64, as well as the specific entries for each contact number for the entry (e.g., a home contact number 68a, a work contact number 68b, and a mobile contact number 68c, etc.). The contact information also may include one or more email addresses 70 (e.g., a text entry), ring tones 72 (which also may be audio clips), images 74, and video clips 76. As described in more detail below, the contact information stored in the contact list 60 may be easily obtained and automatically stored in the contact list 60 via the contact list manager function 12.

As discussed herein, the contact list manager function 12 enables a user of the mobile telephone 10 to quickly and easily add contact information, such as images 74, video clips 76, audio clips 72, etc., to the contact list 60 stored in the mobile telephone 10. For example, during a video call, the user may wish to capture one or more images 74 of the calling/called party, and use these images 74 as contact information for that particular party. Via the contact list manager function 12, the user can capture one or more images 74 and automatically add those images to the contact list 60.

To initiate the capture process, for example, the user may press or otherwise actuate a function key, camera button, or the like of the mobile telephone 10, wherein the key or button is configured to instruct the contact list manager function 12 to perform the requested task. In the exemplary video call, a request to capture an image 74 may cause the contact list manager function 12 to capture and store in the contact list 60 an image 74 as displayed on the display 14 of the mobile telephone 10 at the time the capture request was made. The process of capturing the image 74 may be similar to using a camera, except that the image 74 is obtained via the communication system 48 instead of through a camera device. The captured image 74 then can be stored in the contact list 60 and associated with the identifier 64 of the party (e.g., via the party's telephone number, IP address, name, nickname, etc.).

The identifier 64 may be obtained via a caller ID function, for example, wherein the server 52, via the contact list manager support function 54, provides information such as the phone number or name to the contact list manager function 12. The provided phone number or name then can be used as the identifier 64. Alternatively, the identifier 64 may have been pre-selected by the simple act of calling the other party (e.g., via entering or selecting the called party's number from the contact list).

Using the identifier 64, the contact list manager function 12 can open the contact list 60 and search for the identifier 64. If the identifier 64 is found, then the contact list manager function 12 automatically edits the entry corresponding to the identifier 64 so as to include the new contact information, and then saves the revised contact list 60 to memory. If the identifier 64 is not found in the contact list, then the contact list manager function 12 may automatically create a new entry 62 in the contact list 60 using, for example, the identifier 64.

If the identifier 64 cannot be provided by the contact list manager support function 54, then other means may be used to obtain the identifier 64. For example, in the case of images and/or video clips, the identifier 64 may be obtained using image recognition techniques. More specifically, an existing entry 62 in the contact list 60 may include an image of the party. (e.g., a facial image) and, therefore, the existing image is already associated with an identifier 64. Then, when subsequent images are obtained by the mobile telephone 10, those images may be compared to stored images in the contact list 60. In comparing the images, image recognition techniques may be applied to determine if the newly acquired images match or are a likely match (e.g., 90 percent or greater certainty that the images are of the same individual) with existing images from the contact list. If the new images are determined to match (or are a likely match), then the identifier 64 of the existing image can be associated with the new images.

Alternatively, the user may be prompted for an identifier 64. The user may manually enter the identifier 64, for example, using the key pad 18 of the mobile telephone 10. Alternatively, the identifier 64 may be entered via voice recognition, e.g., by the user speaking the identifier into the microphone 32 of the mobile telephone 10, wherein via voice recognition techniques, the spoken words are converted to meaningful information (e.g., a name, number, etc.). Regardless of how the identifier 64 is obtained, the contact list manager function 12 can automatically enter the new contact information for the entry corresponding to the identifier 64.

In addition to images 74, movie clips 76 and audio clips 72 (which may be used as ring tones, etc.) may be added to the contact list 60. For example, the mobile telephone 10 may be configured with multiple function keys, wherein each function key corresponds to a particular function (e.g., capture image, capture video, capture audio, etc.). Then, when the user is ready to capture contact information, he may simply press the function key that corresponds to the type of contact information that he wishes to capture, and the contact list manager function 12 carries out the request.

For example, the user may wish to capture a video clip 76 during a video telephone call, in which case he may simply press the function key that corresponds to video capture. In this mode, all video images displayed on the display 14 of the mobile telephone 10 during the capture period will be recorded as a video clip. The capture may be terminated, for example, by pressing the video capture function key a second time. Once the video clip has been captured, it can be stored in the contact list 60 as described above with respect to image capture.

Alternatively, the user may wish to capture audio 72, in which case he may press the function key that corresponds to audio capture. In this mode, all audio communicated between the respective parties may be recorded as an audio clip. The audio capture may be terminated, for example, by pressing the audio capture function key a second time.

For example, during a telephone conversation, the user may instruct the other party to recite a message for recordation. The user presses the capture audio function key, and then the other party states “Hi, this is Bob calling, please answer your phone”. Then, the user again presses the record audio function key, which ends the capture session and proceeds to store the audio clip in the contact list 60 as described above. As will be appreciated, the length or size of the captured content (e.g., images, video clips, audio clips, etc.) may be dictated by the amount of memory 16 in the mobile telephone 10, or based on user settable limits.

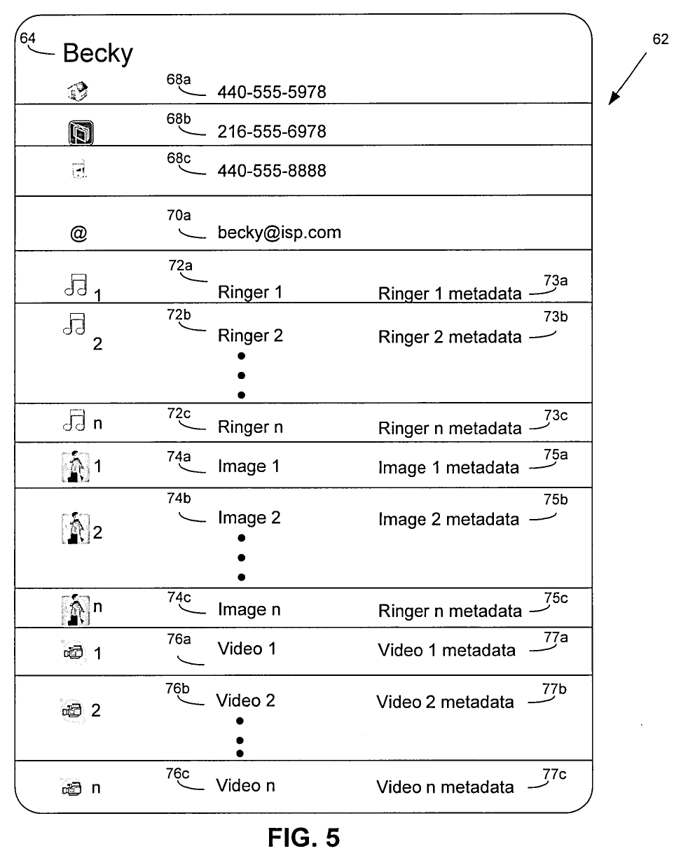

Further, multiple images 74, video clips 76, audio clips 72, etc. may be stored with each entry 62 in the contact list 60. Referring to FIG. 5, there is shown an exemplary entry 62 of the contact list 60 that, in addition to the identifier 64 and various contact numbers 68a, 68b, 68c and email address 70, also includes a plurality of audio clips 72a-72c (e.g., ring tones), images 74a-74c and video clips 76a-76c. Further, associated with each of the plurality of entries is a corresponding metadata or tag entry, i.e., audio metadata 73a-73c, image metadata 75a-75c and video metadata 77a-77c.

The interchangeable terms “metadata” and “tag” refer to information that describes or supplements the data to which the metadata or tag is associated with (e.g., data about data). For example, the metadata or tag may provide information that labels or otherwise associates the data with a particular group. More specifically, the metadata or tag can describe a characteristic of each corresponding entry such as, for example, a chronological characteristic (e.g., a time of day, month, year, season, holiday, etc.) or geographical characteristic (e.g., a location). For example, there may be four images associated with a particular entry 62, wherein each image pertains to a particular season (winter, spring, summer and fall). This seasonal chronological information can be stored with each respective image 74 in the contact list 60 for use at a later time (e.g., during incoming and outgoing calls, slideshows, etc.). Then, while making or receiving a call to/from the party identified in the entry 62, the metadata may be analyzed and an image corresponding to the current season may be displayed on the mobile telephone's display 14 (e.g., if the current season is summer, then the image corresponding to summer will be displayed, and if the current season is winter, then the image corresponding to winter will be displayed). The same is applicable to video clips and audio clips.

Other examples of chronological characteristics include a time of day, which may be general (e.g., morning, afternoon, evening, night) or specific (e.g., the actual time at which the media content was created), a month, a holiday period (e.g., Christmas, Thanksgiving, etc.) or user specified (e.g., a birthday, anniversary, etc.

As noted above, the metadata also may be based on geographical characteristics, such as a general location (e.g., east coast, west coast), a specific state (e.g., Ohio, Florida, etc.), or a country (e.g., USA, Sweden, Canada, etc.). Such information may be based on an area code, country code, or using information obtained from the communication network (e.g., identifying the cell from which a cellular call is made).

For example, if a party frequently travels between the east coast and the west coast of the USA, then the contact information stored in the contact list 60 for that particular party may include the respective locations (e.g., east or west coast). Thus, if the party is calling from the first location (e.g., the east coast), then the ring tone, image and/or video clip may correspond to that first location, and if the party is calling from a second location (e.g., the west coast), the ring tone, image and/or video clip may correspond to the second location.

In another example, the images associated with a particular contact may correspond to the contact number used by the calling party. For example, if the call is to/from the home contact number, the image, video clip and/or audio may correspond to a home setting, while if the call is to/from a work contact number, the image, video clip and/or audio clip may correspond to a work setting.

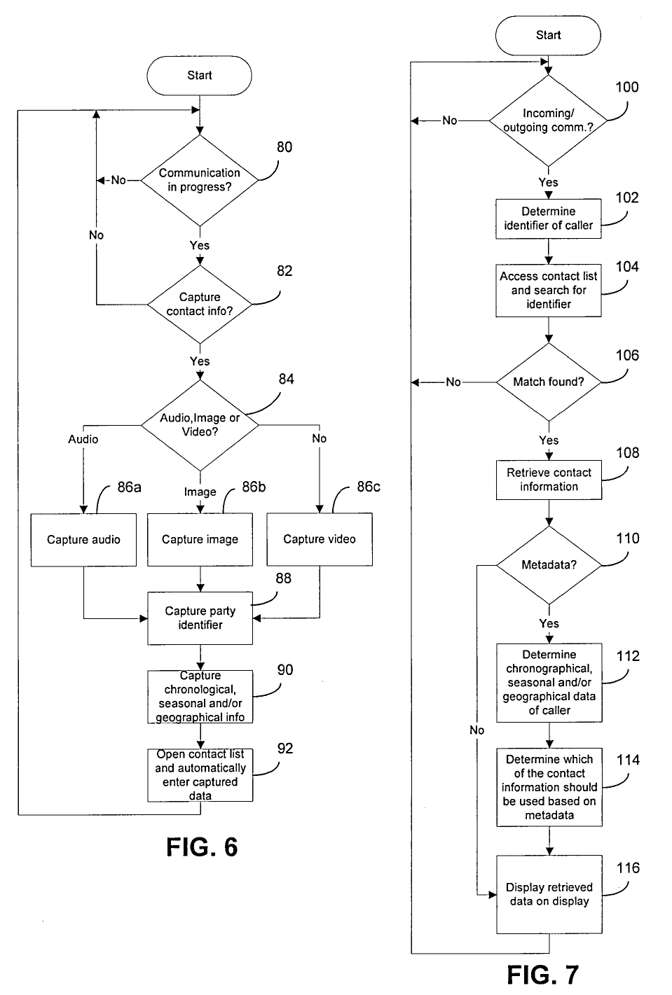

With additional reference to FIGS. 6 and 7, illustrated are logical operations to implement an exemplary method of automatically adding contact information to a contact list 60, and using the contact information to enhance the user's experience with the mobile telephone. The exemplary method may be carried out by executing an embodiment of the contact list manager function 12, for example. Thus, the flow chart of FIGS. 6 and 7 may be thought of as depicting steps of a method carried out by the mobile telephone 10. Although FIGS. 6 and 7 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the contact list manager function 12 may begin in block 80 of FIG. 6 where it is determined whether or not a communication is in progress. A communication, for example, may be a voice call, a video call, or the like. Further, a communication may begin at the moment an incoming communication is placed, detected or otherwise received (e.g., before the call is actually answered). If a communication is not in progress, then the method loops at block 80. If a communication is in progress, then at block 82 it is determined if the calling party's contact information is to be captured.

As discussed herein, capturing of the contact information may be initiated by pressing one or more keys, e.g., function keys, that correspond to predefined commands. For example, a first function key may correspond to capturing an image displayed on the display 14 of the mobile telephone 10 (e.g., an image of the other party acquired during a video call), a second function key may correspond to capturing a video clip displayed on the display 14 of the mobile telephone 10 (e.g., a video of the other party acquired during a video call), and a third function key may correspond to capturing audio of one or both parties to the call.

If a capture command is not detected, then the method moves back to block 80 and repeats. If, however, a capture command is detected, then at block 84 it is determined whether or not the capture command is a command to capture an image, an audio clip or a video clip. Depending on the type of capture command, the method moves to block 86a, 86b or 86c and captures the contact information and then moves to block 88.

At block 88, the party's identifier 64 is captured. As discussed above, the identifier 64 may be information specific to the party (e.g., a name or number). This information may be obtained, for example, using caller ID techniques and/or VoIP communications implemented by the server 52, or the like. As is well known, caller ID provides information, such as name and number, pertaining to the owner of the line from which a call originated. This information may be communicated to the contact list manger function 12 at the time the communication is received. However, if the information cannot be automatically obtained, the user may be prompted to manually enter an identifier (e.g., via the key pad 18 or microphone 32).

Moving to block 90, data that provides at least one characteristic of the captured contact information also may be captured or otherwise obtained. This additional data, which will be stored and associated with the captured contact information as metadata, provides information that can be used when incoming and outgoing calls, etc. are made. For example, the metadata can be used to change the images, videos, sounds, etc. that are presented on the mobile telephone 10 when the metadata corresponds to certain criteria. Further detail regarding these features is described in more detail below with respect to FIG. 7.

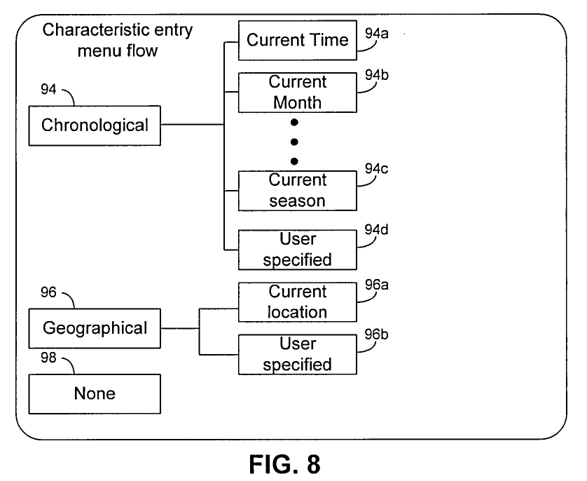

In capturing the metadata, the user may be prompted for the type of characteristic to be associated with the captured data. Referring briefly to FIG. 8, an exemplary menu flow is shown for entering the characteristic data. For example, after capturing the contact information, the user may choose to associate chronological data at block 94, geographical data at block 96, or not to associate data at block 98. If the selection is for chronological data, then the user may choose the current time at block 94a, the current month at block 94b, the current season at block 94c, or any other predefined chronological event. Alternatively, the user may select a custom chronological entry at block 94d, in which a time period may dictated by the user.

Similarly, if the data is to be geographical in nature, the user may select the current location of the other party at block 96a (e.g., the current location as determined by the contact list manager support function 54 or by the communications system 48), or at block 96b the user may manually specify the location. Once the characteristic data is entered, it is associated with the captured image, video and/or audio data.

Next, at block 92, the contact list 60 is opened, and a search is performed for the identifier (e.g., name, number, IP address, etc.) in the contact list 60. If the identifier 64 is found, then the contact information corresponding to that identifier is updated based on the newly acquired contact information. If the identifier 64 is not found, then a new entry in the contact list may be created based on the identifier and the newly acquired contact information stored therein, and then the method moves back to block 80 and repeats.

Moving now to FIG. 7, a flow chart describing an exemplary operation of a mobile telephone 10 that utilizes a contact list that includes contact information having metadata associated therewith is shown. Beginning at block 100, the contact list manager function 12 determines if an incoming or outgoing communication is taking place (e.g., a party is calling the mobile telephone 10, the mobile telephone is being used to call another party). If an incoming or outgoing communication is not taking place, then the method loops at block 100. If an incoming or outgoing communication is taking place, then at block 102, an identifier associated with the called/calling party is determined.

For example, for an outgoing call the identifier may be determined from the number entered into the mobile telephone to make the call. For incoming calls, the identifier may be determined using caller ID functionality, or networking techniques. This may be implemented, for example, in the server 52 as part of the contact list manager support function 54, which then may forward the identifier to the contact list manger function 12.

Once the identifier has been determined, at block 104 a search is performed in the contact list 60 for any entry 62 that matches the identifier 64. At block 106, a determination is made as to whether or not a match has been found. If a match is not found, then the method moves back to block 100 and waits for the next incoming/outgoing communication. If a match is found, then at block 108 the contact information corresponding to the identifier 64 is retrieved from the contact list 60 and at block 110 it is determined if metadata is associated with the contact information.

If metadata is not associated with the retrieved contact information, then the method moves to block 116 and the contact information is displayed on the display 14 and/or played on the speaker 30 of the mobile telephone 10. If metadata is associated with the retrieved contact information, then at block 112 the metadata for each entry is analyzed to determine if it is chronological or geographical in nature (or both). If the metadata is chronological in nature, then it is compared to the current time (e.g., time of day such as morning, noon, evening, the day, the month, the season, etc.) to determine if the metadata corresponds to the current time. If the metadata does correspond to the current time, then the contact information associated with that metadata is selected for use by the mobile telephone 10. Similarly, if the metadata is geographical in nature, a location of the other party is determined (e.g., via caller ID, GPS, server 52, etc.) and that location is compared to the metadata. If the metadata corresponds to the current location of the other party (e.g., it matches or is within a predetermined range of the location), then the contact information associated with that metadata is selected for use by the mobile telephone 10.

At block 116, the selected contact information is displayed on the display 14 of the mobile telephone 10 or played through its sound system. This can include, for example, one or more images, video clips, messages, etc., as well as custom ring tones (e.g., the voice of the calling party, etc.). Further, if multiple images, video clips, etc. are selected (or if the contact information does not include any metadata), the contact information, such as the images, audio clips and/or video clips, may be presented in a slide show format. For example, each image may be displayed for a preset time, and then the next image may be displayed. Further, the audio clip may be played during the slide show. Regarding multiple video clips, they may be played in sequential or random order. This may occur until the call is answered, or for the duration of the call (assuming a non-video call). Once completed, the method moves back to block 100 and repeats.

Accordingly, an electronic device and method for automatically capturing, storing and using contact information of an electronic device's contact list has been described. The contact list manager function 12 facilitates entry of user specific information, including media content, thereby enhancing the user's communication experience.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable electronic device, comprising:
call circuitry operative to establish a call over a communication network;
a contact list stored in memory of the electronic device, said contact list configured to store contact information for a plurality of contacts; and
logic circuitry operative to capture at least a portion of new contact information during a call with a contact of the plurality of contacts, said new contact information obtained via the communication network, and to automatically enter the new contact information into the contact list during or after the call.

2. The device of claim 1, wherein the logic circuitry that automatically enters the new contact information includes logic circuitry operative to associate the new contact information with an identifier of the contact.

3. The device of claim 2, wherein the logic circuitry that associates the new contact information with the identifier includes logic circuitry operative to capture at least one of a name or number of the contact.

4. The device of claim 2, wherein the logic circuitry that associates the new contact information with the identifier includes logic circuitry operative to implement image recognition to match a new image with an existing image in the contact list, and to associate the new image with an identifier associated with the existing image.

5. The device of claim 1, wherein the logic circuit is further operative to capture at least one image of the contact, at least one video of the contact, or at least one audio clip of the contact.

6. The device of claim 5, wherein the at least one image is captured in response to a key actuation on the electronic device, said key corresponding to a capture command.

7. The device of claim 5, wherein the logic circuit is further operative to capture a plurality of images or a plurality of videos for a particular contact.

8. The device of claim 1, wherein the logic circuit is further operative to capture the contact information prior to answering the call.

9. The device of claim 1, wherein the logic circuit is further operative to store at least one tag with the contact information, said at least one tag corresponding to at least one of chronological data or geographical data associated with the contact.

10. The device of claim 9, wherein the logic circuit is further operative to use the contact information corresponding to a particular contact as an alert upon receiving a call from the particular contact.

11. The device of claim 8, wherein the logic circuit is further operative to use the at least one tag to determine which portion of the contact information to display on a display device of the electronic device or play through an audio output device of the electronic device.

12. The device of claim 8, wherein chronological data includes a time, a month, a date, or a season, and wherein geographical data includes a location of the contact.

13. A method of using contact information in a contact list of a portable electronic device, wherein said portable electronic device includes call circuitry operative to establish a call over a communication network, comprising:
capturing at least a portion of new contact information during a call, said new contact information obtained via the communication network and corresponding to a contact; and
automatically entering the new contact information into the contact list during or after the call.

14. The method of claim 13, wherein automatically entering the new contact information includes associating the new contact information with an identifier of the contact.

15. The method of claim 14, wherein associating the new contact information with the identifier includes implementing image recognition to match a new image with an existing image in the contact list, and associating the new image with an identifier associated with the existing image.

16. The method of claim 13, wherein capturing at least a portion of the contact information during the call includes capturing at least one image of the contact, at least one video of the contact, or at least one audio clip of the contact.

17. The method of claim 16, wherein capturing at least a portion of the contact information includes capturing at least one of a name, number, or IP address of the contact.

18. The method of claim 16, wherein capturing is initiated by actuating a key on the electronic device, said key corresponding to a capture command.

19. The method of claim 13, wherein capturing at least a portion of the contact information during the call includes capturing the contact information prior to answering the call.

20. The method of claim 16, wherein capturing at least one image or at least one video includes capturing a plurality of images or a plurality of videos of a particular contact.

21. The method of claim 13, wherein automatically entering the new contact information into the contact list includes storing at least one tag with the contact information, said at least one tag corresponding to at least one of chronological data or geographical data associated with the contact.

22. The method of claim 21, further comprising using the contact information corresponding to a particular contact as an alert upon receiving a call from the particular contact.

23. The method of claim 22, wherein using the contact information includes using the at least one tag to determine which portion of the contact information to use.

24. The method of claim 22, wherein using the contact information includes at least one of displaying the contact information on a display device of the electronic device or playing the contact information through an audio output device of the electronic device.

25. The method of claim 21, wherein chronological data includes a time, a month, a date, or a season, and wherein geographical data includes a location of the contact.

26. A computer program embodied on a computer readable medium, for using contact information in a contact list of a portable electronic device, wherein said portable electronic device includes call circuitry operative to establish a call with another contact over a communication network, comprising:
code that captures at least a portion of new contact information during a call with the contact, said new contact information obtained via the communication network and corresponding to a contact; and
code that automatically enters the new contact information into the contact list during or after the call.
